(19) United States
(12) Patent Application Publication
(10) Pub. No.: US 2017/0010780 A1
(43) Pub. Date: Jan. 12, 2017

(54) PROGRAMMABLE TOUCHSCREEN ZONE FOR MOBILE DEVICES

(71) Applicant: Hand Held Products, Inc., Fort Mill, SC (US)

(72) Inventors: John F. Waldron, JR., Louisville, KY (US); Manjul Bizoara, Hyderabad AP (IN)

(21) Appl. No.: 14/791,524

(22) Filed: Jul. 6, 2015

(51) Int. Cl. G06F 3/0488; G06F 3/0482; G06F 3/16; G06F 3/0481

(52) U.S. Cl. CPC G06F 3/0488; G06F 3/04817; G06F 3/0482; G06F 3/167

(57) ABSTRACT

A GUI is described, which is operable on mobile device touchscreens. The GUI has a programmable scan zone, placed over a first portion of the touchscreen, operable on the touchscreen for receiving a first input at an instance in time, and invoking one or more functions of the mobile device, based on a user programmed context, programmably in response to that received input. The GUI also comprises a configurable virtual trigger icon placed over a second portion of the touchscreen with an area smaller than the first. The icon is operable for receiving a second input and, based on a user configured selection or context, triggering responsively a corresponding action related to the one or more functions of the mobile device. The mobile device functions include applications, tools, macros or menus related to collecting or accessing visible graphic and other data (e.g., barcodes, images, RFID/NFC tags).

### FIELD

The present invention relates generally to mobile devices. More specifically, an embodiment of the present disclosure relates to a touchscreen based GUI for mobile devices.

### BACKGROUND

Generally speaking, contemporary mobile devices such as smartphones, tablet style computers, portable data terminals (PDTs) and personal digital assistants (PDAs) are operable with component user interface (UI) features. The UIs allow the input of selections, commands and data to the devices, and to activate and use applications and other features thereof.

Mobile device UIs may include at least one trigger switch, which is operable electromechanically. Mobile device UIs may also include a touchscreen based graphical user interface (GUI). Touchscreens comprise an interactive display operable for capturing user inputs applied haptically to input fields and/or selectable icons or menu items, rendered with images thereon.

At least partly in view of their small sizes, convenient form factors, light weights, and general versatility and capability, the mobile devices are frequently used “on-the-go” and while users are engaged in other tasks. Not infrequently, the mobile devices may, in fact, be applied to the tasks at hand.

For example, a mobile device may be used to read bar code patterns, capture snapshot photographs, and/or input text or numerical data. In such on-the-go operating situations, the mobile devices may be used while held in one hand. Single handed operation allows the inputs to be made with the UIs, while the users have another hand free to keep at the task.

The touchscreen based GUIs demonstrate some advantages over the trigger switch UIs for continuous or frequently repeated user inputs. For example, the trigger buttons typically provide “hard triggers,” which must be actuated using somewhat more force than may be used typically for actuating the touchscreens haptically.

The touchscreens are thus typically easier to use, ergonomically, relative to using the trigger buttons in single handed operation of the mobile devices. This advantage may be especially noticeable while making continuous or repeated inputs to the mobile devices with the touchscreens while performing other tasks.

A number of contemporary mobile devices are fully touch based. As such, these mobile devices may lack front mounted trigger buttons. Even with some mobile devices that may have them, using the front mounted trigger buttons to make inputs during single handed operations may be complicated or difficult because the positions in which they are disposed may not be optimal ergonomically.

Moreover, trigger buttons are typically configured to provide a specific functionally at any given time. Support or options for multipurpose use of the trigger buttons, based on a user context, are typically lacking or, if present, activated upon completing one or more nontrivial programming tasks, and/or entering sometimes multiple selections.

Some mobile devices provide settings options for customized trigger button functionality in some applications. Once customized however, the trigger button functionality cannot typically be personalized according to a user's preferences. For example, the trigger buttons cannot be typically configured for receiving inputs corresponding to customized gestures.

Issues or approaches discussed above within this background section may, but not necessarily have been observed or pursued previously. Unless otherwise indicated to the contrary, it is not to be assumed that anything in this section corresponds to any alleged prior art merely by inclusion in this section.

### SUMMARY

A need exists for a UI, which would be operable with ergonomically light touch-based inputs applied with a single hand to a touchscreen display of a mobile device. A need also exists for the touchscreen to be configurable, optionally, for multiple purposes based on contexts selected by a user of the mobile device. Further, a need exists for the touchscreen to be reconfigurable, based on personalized user preferences, including for functionality triggered by gesture based inputs customized by the user.

Accordingly, in one aspect, the present invention embraces a touchscreen based graphical user interface (GUI). In an example embodiment, a GUI is operable with an ergonomically light touch with single inputs applied to a touchscreen display of a mobile device. The touchscreen is configurable, optionally, for multiple purposes based on contexts selected by a user of the mobile device. Further, the touchscreen is reconfigurable, based on personalized user preferences. The touchscreen is triggered operationally with inputs based on gestures, which are customizable by the user.

An example embodiment relates to a GUI operable on a touchscreen component of a mobile device. The GUI comprises at least one programmable scan zone, referred to herein as a “scan zone” or “programmable scan zone,” which is disposed in an interactive rendering over a first portion of the touchscreen. The GUI is operable on the touchscreen for receiving a first input at an instance in time, and for invoking one or more functions of the mobile device based on user programmed contexts, in response to the received first input.

The GUI also comprises at least one configurable virtual trigger icon, referred to herein as a “virtual trigger,” “configurable virtual trigger,” or “virtual trigger button,” which is disposed in an interactive rendering over a second portion of the touchscreen. The second portion comprises an area smaller than an area of the first portion. The at least one virtual trigger icon is operable, based on a user configured context, for receiving a second input and triggering a corresponding action related to the one or more functions of the mobile device in response to the second input.

The functions of the mobile device may comprise one or more applications, tools, macros, or menus and sub-menus (“applications/tools”). The applications/tools may related to collecting or accessing data presented graphically (e.g., barcodes), visibly (e.g., images), electromagnetically (e.g., RFID and NFC tags), or sonically (e.g., voice commands or audio data).

At the time instance at which a given application/tool is invoked, at least one application may already be running on the mobile device. The one or more functions of the mobile device invoked programmably in response to the received input may be performed concurrently with, or supersede, a function of the at least one running application, according to a user preference. The programmable scan zone (“scan zone”) and/or the configurable virtual trigger icon (“virtual trigger”) are rendered on the

touchscreen over a presentation related to the running application.

The accessed graphic or visual data may comprise barcode patterns and/or static and/or dynamic images (e.g., photographs and/or video). The collected electromagnetic data may comprise radio frequency identification (RFID) tags and/or near field communication (NFC) tags. The collected or accessed sonic data may comprise audio inputs and/or inputs related to voice-recognition and/or voice-activation functions of the mobile device.

The at least the second input may comprise haptic gestures, including, for example, long-presses and/or long-presses applied with swipes. A size or dimension of the area of the first portion of the touchscreen, or a location thereof, may be adjusted based on one or more haptic inputs to the touchscreen.

The GUI may also comprise at least a second programmable scan zone, which is disposed as an interactive rendering over a third portion of the touchscreen. The third portion comprises an area of the touchscreen larger than the area of at least the second portion thereof. The third portion is operable on the touchscreen for receiving a third input. One or more functions of the mobile device are invoked, based on another user programmed context, in response to the received third input.

Based on an activation related input, the at least one programmable scan zone and/or the at least the second programmable scan zone are, selectively, active or inactive.

The at least one programmable scan zone may comprise one or more interactive zone-pages. At least one of the one or more interactive zone-pages may comprise a plurality of (multiple) interactive fields, sub-zones or sub-pages.

In another aspect, the present invention embraces a method operating a mobile device. In an example embodiment, a method for operating the mobile device comprises rendering at least one programmable scan zone over a first portion of a touchscreen of the mobile device.

The rendered at least one programmable scan zone is operable on the touchscreen for receiving a first input made upon an instance in time. One or more functions of the mobile device are invoked, according to a user-programmed context in response to the received first input.

At least one configurable virtual trigger icon is disposed over a second portion of the touchscreen. The second portion of the touchscreen has an area smaller than an area of the first portion. The rendered at least one configurable virtual trigger icon is operable on the touchscreen for receiving a second input.

An action related to the one or more functions of the mobile device is triggered, based on a user configured context, in response to the second input. The functions of the mobile device comprise applications, tools, macros or menus related to collecting or accessing data presented graphically or visually (e.g., barcode patterns, photographs, video), electromagnetically (e.g., RFID and NFC tags), or sonically (e.g., voice commands or audio data).

In yet another aspect, the present invention embraces a mobile device. In an example embodiment, a mobile device comprises a computer apparatus operable for performing data processing functions in a network environment, which include communicating with other computers. The mobile device comprises at least one processor component. The at least one processor component may comprise a microprocessor, operable as a central processing unit (CPU) of the mobile device. Another processor may be operable as a graphics processing unit (GPU) and/or digital signal processor (DSP) of the mobile device. The CPU of the mobile device may also be operable for computing DSP related functions.

The mobile device also comprises a non-transitory computer readable storage medium, such as memory, and drives and/or other storage units. The non-transitory computer readable storage medium comprises instructions, which when executed by the at least one processor causes or controls a process performed therewith. The process may comprise one or more of the method steps summarized in above. The mobile device may be operable with functions multiple or various features.

The features relate to functionality of the mobile device. The features comprises applications, tools and tool sets, menus (and submenus), and macros (“applications/tools”). The applications/tools may relate to scanning and reading (“scanning”) barcodes and other patterns of graphic data, capturing and processing images and video data, scanning RFID and NFC tags, and voice and/or audio data. Mobile devices may comprise smartphones, tablets and/or other mobile computer devices, PDTs and/or PDAs.

### BRIEF DESCRIPTION OF THE DRAWINGS

FIG. 1 depicts a mobile device, with which an example embodiment of the present invention may be practiced;

FIG. 2 depicts an example mobile device with a touchscreen GUI, according to an example embodiment of the present invention;

FIG. 3 depicts a first screenshot of the mobile device touchscreen, according to an example embodiment;

FIG. 4 depicts a second screenshot of the mobile device touchscreen, according to an example embodiment;

FIG. 5 depicts a third screenshot of the mobile device touchscreen, according to an example embodiment;

FIG. 6 depicts a fourth screenshot of the mobile device touchscreen, according to an example embodiment;

FIG. 7 depicts a flowchart for an example process for operating the mobile device with the touchscreen GUI, according to an example embodiment; and

FIG. 8 depicts an example computer and networking platform, with which an embodiment of the present invention may be practiced.

### DETAILED DESCRIPTION

An example embodiment of the present invention embraces a touchscreen based GUI, which is operable with a light touch ergonomically for single handed use from the front of a mobile device. In an example embodiment, the touchscreen is configurable, optionally, for multiple purposes based on contexts selected by a user of the mobile device. Further, the touchscreen is reconfigurable, based on personalized user preferences. In an example embodiment, the touchscreen is triggered operationally with inputs based on gestures, which are customizable by the user.

Overview.

An embodiment of the present invention is described below in relation to an example graphical user interface (GUI) operable on a touchscreen component of a mobile device. The GUI comprises at least one programmable scan zone, which is disposed in an interactive rendering over a first portion of the touchscreen. The GUI is operable on the touchscreen for receiving a first input at an instance in time, and for invoking one or more functions of the mobile device based on user programmed contexts, in response to the received first input.

The GUI also comprises at least one configurable virtual trigger icon, which is disposed in an interactive rendering over a second portion of the touchscreen. The second portion comprises an area smaller than an area of the first portion. The at least one virtual trigger icon is operable, based on a user configuration, for receiving a second input and triggering a corresponding action, based on a user configured context, related to the one or more functions of the mobile device in response to the second input.

The functions of the mobile device may comprise one or more applications, tools, macros, or menus and sub-menus (“applications/tools”). The applications/tools may related to collecting or accessing data presented graphically (e.g., barcodes), visibly (e.g., images), electromagnetically (e.g., RFID and NFC tags), or sonically (e.g., voice commands or audio data).

At the time instance at which a given application/tool is invoked, at least one application may already be running on the mobile device. The one or more functions of the mobile device invoked programmably in response to the received input may be performed concurrently with, or supersede, a function of the at least one running application, according to a user preference. The programmable scan zone (“scan zone”) and/or the configurable virtual trigger icon (“virtual trigger”) are rendered on the touchscreen over a presentation related to the running application.

The accessed graphic or visual data may comprise barcode patterns and/or static and/or dynamic images (e.g., photographs and/or video). The collected electromagnetic data may comprise radio frequency identification (RFID) tags and/or near field communication (NFC) tags. The collected or accessed sonic data may comprise audio inputs and/or inputs related to voice-recognition and/or voice-activation functions of the mobile device.

The at least the second input may comprise haptic gestures, including, for example, long-presses and/or long-presses applied with swipes. A size or dimension of the area of the first portion of the touchscreen, or a location thereof, may be adjusted based on one or more haptic inputs to the touchscreen.

The GUI may also comprise at least a second programmable scan zone, which is disposed as an interactive rendering over a third portion of the touchscreen. The third portion comprises an area of the touchscreen larger than the area of at least the second portion thereof. The third portion is operable on the touchscreen for receiving a third input. One or more functions of the mobile device are invoked, based on another user programmed context, in response to the received third input.

Based on an activation related input, the at least one programmable scan zone and/or the at least the second programmable scan zone are, selectively, active or inactive.

The at least one programmable scan zone may comprise one or more interactive zone-pages. At least one of the one or more interactive zone-pages may comprise a plurality of (multiple) interactive fields, sub-zones or sub-pages.

The GUI described herein represents an example embodiment of the present invention in relation to a first aspect. A mobile device and a method are also described herein, which each represent example embodiments of the present invention in relation to another aspect.

Mobile Devices.

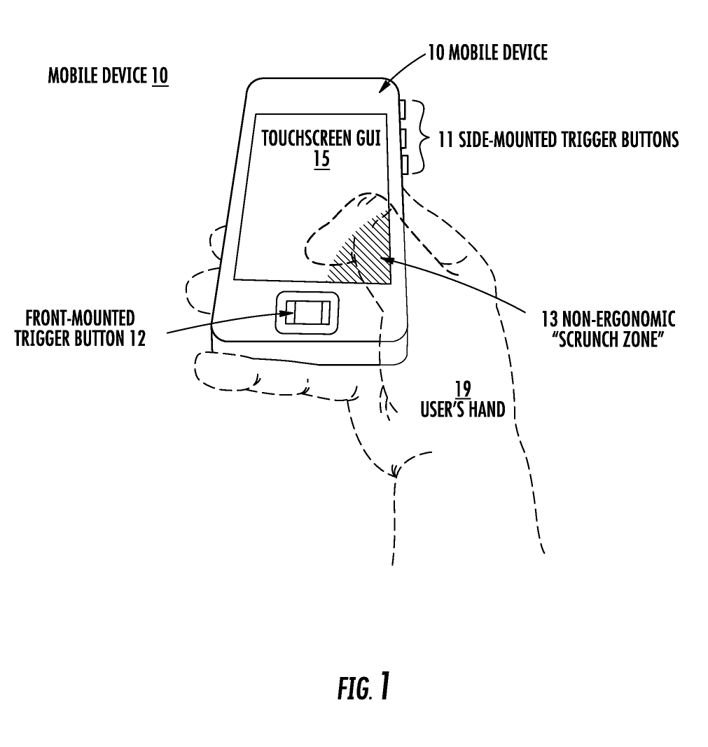

FIG. 1 depicts an example of a mobile device 10, with which an embodiment of the present invention may be practiced or compared. The mobile device 10 has one or more side mounted trigger buttons 11. The trigger buttons 11 may be used to turn the device 10 on and off, to control an audio volume or the like. The mobile device 10 may also have a front mounted trigger button 12, which may be mounted under a display component, which may also be operable as a touchscreen based GUI (“touchscreen”) 15. Users may operate the mobile device 10 as shown while holding it in a single hand 19, in which the user's extended fingers support the mobile device 10 while its trigger button 12 and touchscreen 15 are operated by the user's thumb.

The user's hand 19 may operate the touchscreen 15 and the front mounted trigger button 12, e.g., using its opposable thumb. To operate the front mounted trigger button 12 however, the user exerts a force sufficient for its actuation and, to operate the touchscreen 15 for activation of (a) feature(s) rendered in a “scrunch zone” area 13 thereof, the user bends the thumb sharply.

Especially with repetitive, continuous or near-continuous (“repetitive”) use however, such operation of the front mounted trigger button 12 and the scrunch zone 13 area of the touchscreen 15 may lead to undesirable related ergonomic factors. For example, continuous operations of this sort may cause fatigue of the hand 19 and/or irritation of one or more joints of its thumb.

Embodiments of the present invention obviate the repetitive use of the trigger button 12 and the scrunch zone 13 of the touchscreen 15. Thus, embodiments of the present invention may function to effectively ameliorate or deter development of the undesirable ergonomic effects related to such use.

Example Touchscreen GUI.

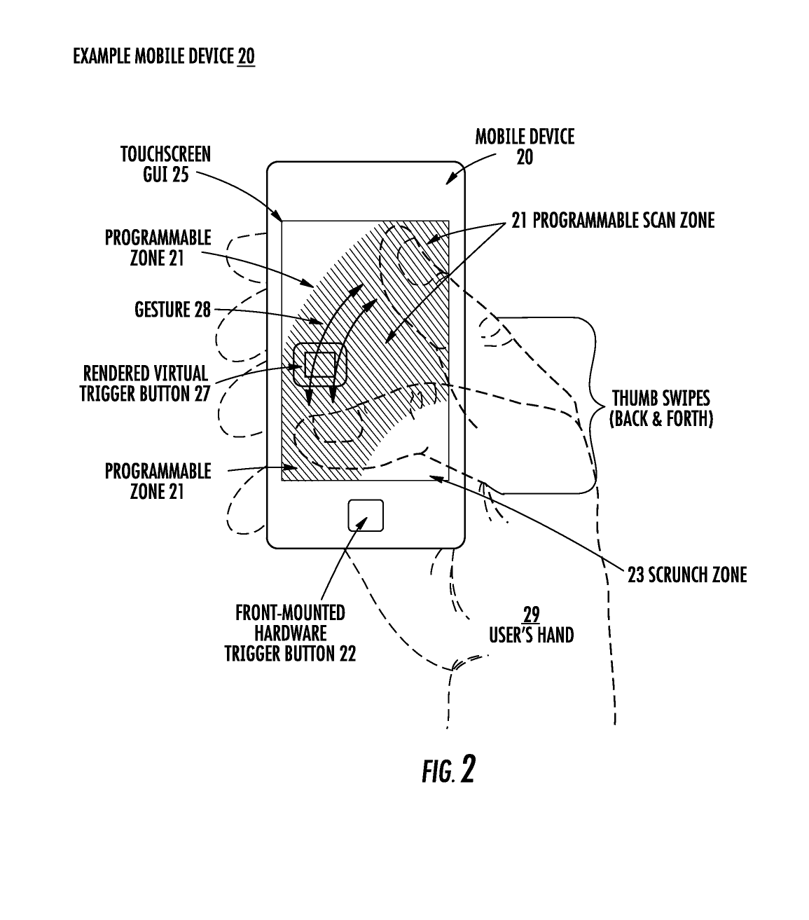

FIG. 2 depicts an example mobile device 20 with a touchscreen GUI, according to an example embodiment of the present invention. Like the mobile device 10, the mobile device 20 comprises a touchscreen 25.

The mobile device 20 may also have a hardware based front mounted electromechanically actuated trigger button 22. However, an embodiment of the present invention may be practiced with or without a hardware based trigger button.

Further, in relation to the opposable thumb of a user's hand 29, an area of the touchscreen 25 may also correspond to a scrunch zone 23. However, embodiments of the present invention function to obviate repetitive operation of the touchscreen 25 in a scrunch zone 23.

The mobile device 20 comprises an area 21 of the touchscreen GUI 25. The area 21 comprises a programmable scan zone, which may be mapped by user programming to activate or call a function, macro, menu or feature associated with an application or utility of the mobile device 20.

A portion of the programmable area 21 may be configured as a virtual trigger 27 operable for detecting one or more customized gestures or other haptic user inputs, represented by a gesture 28. The gesture 28 corresponds to a user configured context or selection. The gesture 28 may comprise one or more of a long-press, a long-press with a swipe, and various other configurable haptic inputs.

Each of the one or more gestures may be assigned uniquely to activating, calling or performing a specific function or macro; e.g. barcode scanning and/or camera operation. Dimensions, contour and location of an area of the touchscreen GUI 25 corresponding to the programmable scan zone 21 may be personalized by user via the GUI 25.

The mobile device 20 may comprise a smartphone, tablet or other mobile computer device, such as a PDT or PDA.

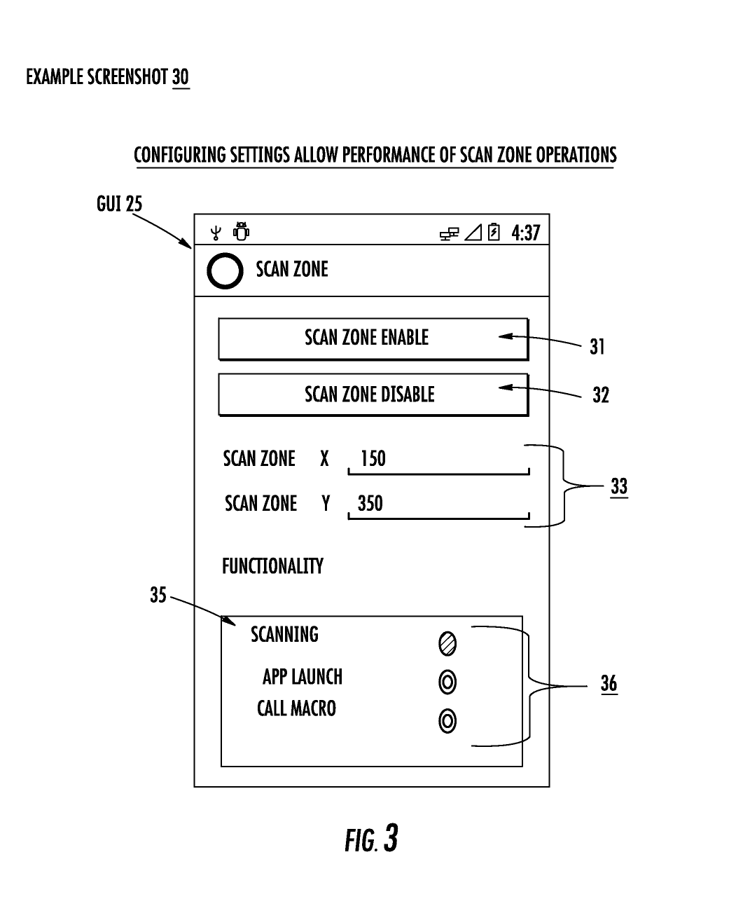

FIG. 3 depicts a first example screenshot 30 of the mobile device touchscreen, according to an embodiment. The touchscreen 30 is rendered on the touchscreen GUI 25.

A configurable virtual trigger 31 is operable for activating the programmable scan zone 21. A configurable virtual trigger 32 is operable for deactivating the programmable scan zone 21. A field 33 is operable for receiving numeric user inputs for configuring horizontal (e.g., ‘x’) and vertical (e.g., ‘y’) dimensions of the programmable scan zone 21. A field 35 is operable for receiving a plurality of (“multiple”) inputs 36.

Each of the multiple inputs 36 is operable for programming a user selection for a particular feature of function of the mobile device 20. For example, selections according to the inputs 36 may correspond to “scanning” (e.g., barcodes, RFID and/or NFC tags, etc.), launching applications (e.g., camera), or calling a macro (e.g., relating to an installed software program) according to an input made in the programmable scan zone 21. Configuration and control settings may thus include activating and deactivating one or more programmable scan zones, setting an activation interval in relation to a specific period of time (e.g., a particular duration in milliseconds or seconds), assigning particular applications/tools, browsing and selecting applications/tools, naming an application or entering an application name or identifier, configuring settings related to scanning/reading barcodes (e.g., continuous read intervals and scanning timeouts) and camera operations.

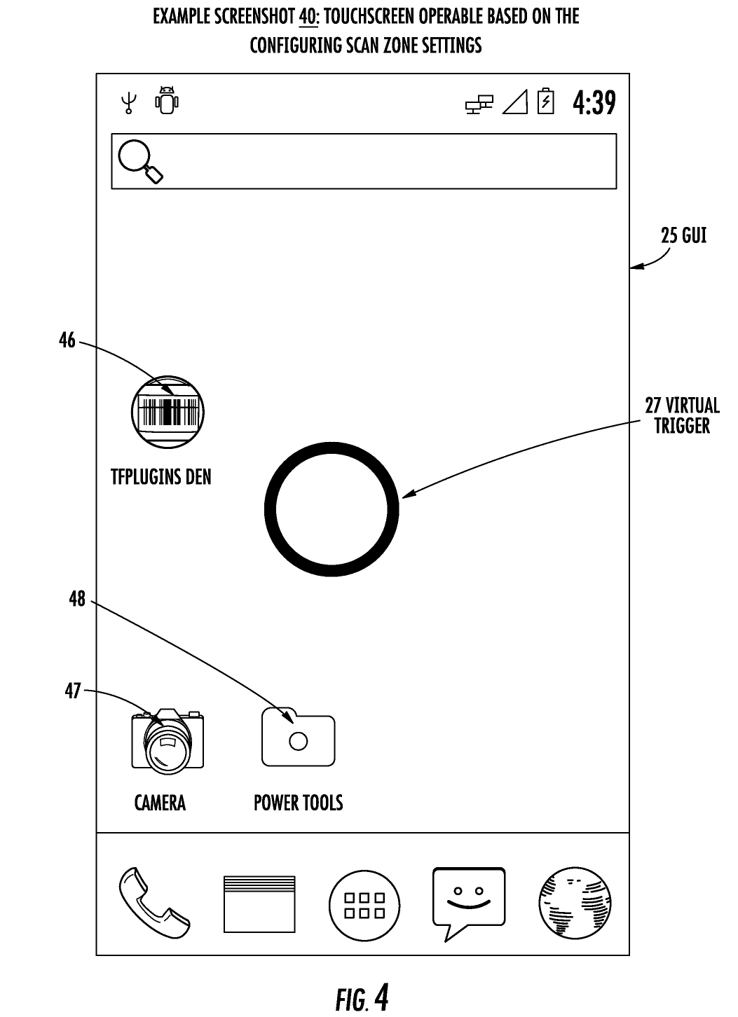

FIG. 4 depicts a second example screenshot 40 of the mobile device touchscreen, according to an embodiment. The touchscreen is operable based on the configuration of the scan zone settings. Example embodiments of the present invention may be implemented in which the configurable virtual trigger 27 is rendered as an overlay on screens associated with applications that may be active at a given time.

Example embodiments of the present invention may be implemented in which the virtual trigger button 27 is rendered over an interactive “wallpaper” rendering of the touchscreen 25, as shown in FIG. 4. The wallpaper also renders touch activated icons 46, 47 and 48, which are operable respectively for accessing or activating a barcode scanner, a camera, and a tool set feature of the mobile device 20.

The wallpaper may also present indicator symbols relating to time and power level, signal strength, and states of the mobile device 20. Further, the wallpaper may present touch-interactive icons for accessing or activating telephone, directory, messaging, browsing, and various other operability features of the mobile device 20.

The wallpaper may comprise a home, initial, default, and/or base presentation, rendered upon accessing or activating the touchscreen 25 (e.g., over any of various graphic backgrounds). As each feature of the mobile device 20 is activated, the appearance of the touchscreen changes, e.g., relative to the wallpaper.

For example, as the camera application is launched by operating the corresponding camera icon 47, the touchscreen 25 renders the image sensed by the camera feature and icons associated therewith. An example camera icon is operable for “triggering a shutter component” of the camera to capture a photograph therewith. The touchscreen 25 thus presents a camera related appearance while the camera feature is activated.

Moreover, example embodiments are operable for rendering the virtual trigger button 27 over the sensed image rendered in the camera related appearance of touchscreen 25 while the programmable scan zone 21 and/or the virtual trigger 27 are enabled or activated. Not dissimilarly, the appearance of the touchscreen changes as the barcode scanner feature is activated by the icon 46, and/or as the tool set feature is activated by the icon 48.

Notwithstanding the changing appearance of the touchscreen 25 to correspond with whichever of the features of the mobile device 20 may be activated or in use, example embodiments are operable for rendering the virtual trigger button 27. The virtual trigger 27 is rendered over the touchscreen 25 in whichever appearance, related to any corresponding activated feature, may be displayed while the programmable scan zone 21 and/or the virtual trigger 27 are enabled or activated.

In an example embodiment, the tools, functions, macros and applications programmed in relation to inputs made via the virtual trigger 27 may be launched or accessed when another application is in use. For example, the bar code scanner may thus be activated while using a camera tool, or vice versa.

The barcode scanner may also be activated directly from the wallpaper, initially, using the corresponding barcode icon 46. While using the barcode scanner, the user may decide to capture a photograph in relation to a particular barcode or an item associated or identified therewith.

The barcodes may comprise two dimensional (2D) arrays of graphic data. Barcode scanner features of the mobile device 20 may be operable for reading one or more barcode patterns including Han Xin, Quick-Read (QR), universal product code (UPC), and/or dot code patterns, and/or patterns representing a portable document file (PDF), such as ‘PDF-417’ (Portable Document File with four vertical bar symbols disposed over 17 horizontal spaces) patterns.

An example embodiment is implemented in which, to take photographs, the user may activate the camera via the virtual trigger 27, without leaving or minimizing the barcode scanner application, changing the appearance of the touchscreen 25 in relation thereto, moving it to background, or re-accessing the wallpaper, etc. The virtual trigger 27 may thus activate any feature of the mobile device 20 for which it is programmed while using any other feature and with whichever corresponding appearance is presented by the touchscreen 25.

One or more of the user selections 36 may be received by inputs to the field 35. The field 35 is operable for calling or activating and/or launching applications, tools, macros, menus or sub-menus (“applications/tools”). The applications/tools may relate to the scanner, camera, and/or other features or functionalities of the mobile device 20.

An example embodiment implements a software service or component to reserve a programmable area of the touchscreen GUI 25 and map it to a programmable feature or tool, based on a user programmed function. The feature/tool may be activated and/or controlled based one or more inputs such as the gesture 28, made using the configurable virtual trigger 27 and/or over the programmable scan zone 21.

An example embodiment of the present invention relates to one or more non-transitory computer readable storage media comprising instructions. The instructions are stored tangibly in the non-transitory media, and associated with software features operable for causing a processor of the mobile device 20 to perform one or more functions or method steps.

The software feature, functions or steps (“feature”) may relate to programming characteristics of the programmable touch area 21. The feature may also relate to supporting or enabling haptic touch-actuated inputs, commands, and triggers made with the programmable area 21 and/or the virtual trigger 27. The feature may further relate to configuring and controlling settings and tools accessed or actuated with the programmable area 21 and/or the virtual trigger 27.

The characteristics of the programmable touch area 21 that may be programmable in relation to the feature comprise a location on the touchscreen GUI for rendering the programmable scan zone 21. The characteristics may also comprise a size of the programmable scan zone 21 in relation to the area of the touchscreen GUI 25 and/or one or more dimensions associated with an area of the touchscreen GUI 25, over which the programmable scan zone may be disposed.

Further, the characteristics may comprises a shape rendered on the touch screen GUI 25, the contours of which circumscribing a boundary of the programmable area 21 in relation to the rest of the area of the touchscreen GUI 25. For example, the shape of the programmable scan zone 21 may be configured to conform to a circle, square or other rectangle, or to a more complex contour such as a star.

Embodiments of the present invention may be implemented for supporting or actuating a plurality of inputs, commands, and triggers using the gesture 28. The inputs, commands, and triggers (“inputs”) may relate to launching an application or tool or calling a menu or sub-menu associated therewith. The inputs may also actuate voice actuated inputs for start and stop related actions.

Further, the inputs may actuate one or more actions associated with gathering or accessing data. The gathering or accessing the data may comprise scanning and reading barcode patterns and/or RFID or NFC tags. The gathering or accessing the data may also comprise capturing images, such as actuating a camera to take a photograph or record video data.

Embodiments of the present invention may also be implemented for configuring and controlling settings. The settings may relate to activating and deactivating the programmable scan zone 21 and/or the virtual trigger 27. The settings may also relate to the duration of an interval associated with the activation.

Further, the settings may relate to assignment of features or resources for particular applications, such as browsing and selecting an application and entering application names. In applications associated with reading barcode patterns, the settings may relate to a duration for a continuous read interval and/or triggering a timeout for a scanning operation.

An example embodiment relates to programming the area/zone in the touchscreen 25 for invoke specific function, macro, application or features based on a user input. The area 25 is programmed concurrently, in relation to the applications, which may be running on the mobile device 20 (e.g., at the instance of time corresponding to receipt of the user input).

An example embodiment is implemented in which a portion 27 of the programmable area 21 is configured as a virtual trigger button, switch or the like. The virtual trigger 27 is operable for detecting user inputs comprising various customized gestures, represented by the gesture 28.

The customized gestures may comprise, for example, a long-press, a long-press combined with a swipe, and others. The gestures are operable for supporting, triggering, actuating, launching, calling or activating custom actions of features of the mobile device 20. The customized gestures are programmed or configured to correspond to a respective action.

Each of the gestures may be assigned to perform a specific function. The functions to which the gestures are assigned relate to barcode scanning, reading, etc. (“scanning”); RFID and NFC scanning, card scanning, image capture and video recording by camera and video features of the mobile device 20, activating a voice recognition input feature thereof, launching particularized menus for inputting selections related to the functions or features, sub-menus for inputting further selections related thereto, or other functions/features of the mobile device 20.

Using its GUI feature, users may personalize the size, contours and location with which the programmable scan zone 21 is rendered on the touchscreen 25. For example, a gesture programmed or configured to correspond to a ‘personalization’ mode may comprise an input made to the virtual trigger 27. Upon entering the personalization mode, the programmable scan zone 21 may be re-sized, moved, or re-shaped upon the touchscreen 25 according to the user's inputs made therewith using a fingertip (or, e.g., a stylus).

The programmable scan zone 25 is then overlaid operably on any application running, and over any corresponding screen that may be rendered or presented on the touchscreen 25 at a given time. Thus, embodiments allow any programmed function or application to be launched, called, actuated or activated when the user is using another application. The camera may thus be launched for example while using the barcode scanner.

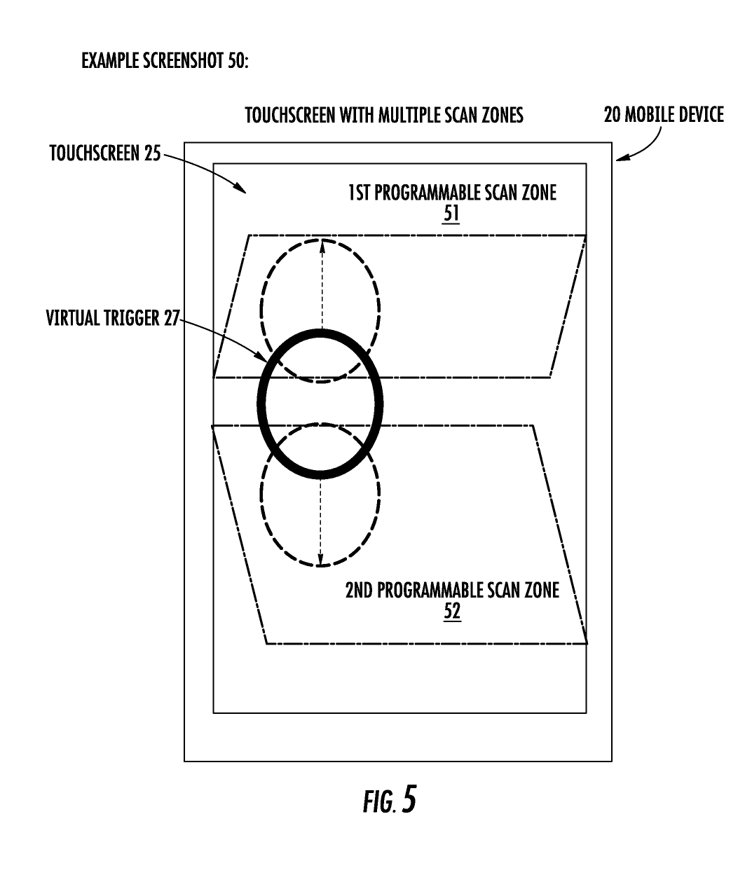

The mobile device 20 may also comprise multiple programmable scan zones. FIG. 5 depicts a third example screenshot 50, according to an embodiment. The screenshot 50 depicts an example plurality of scan zones operable on the touchscreen GUI 25.

A first programmable scan zone 51 is disposed over a first section of the touchscreen 25, which has a first area or size, shape and contour. The first scan zone 51 may be operable with a first set of gestures for actuating a corresponding first set of applications, tools, etc. (“applications/tools”).

At least a second programmable scan zone 52 is disposed over a second section an area of the touchscreen 25, which has a second size or area, shape and contour. In an example embodiment, the mobile device 20 may also comprise up to any practical and practicable number of additional scan zones, which are represented in the present description with reference to the second scan zone 52.

Characteristics and functionality of each of the multiple scan zones may resemble, match or differ from characteristics and functionality of each of the other multiple scan zones. For example, the second scan zone 52 may be distinct from the first scan zone 51, or match one or more characteristics thereof (e.g., in relation to functional operability, size or area, shape and/or contour).

The second scan zone 52 may be operable with a second set of gestures for actuating a corresponding second set of applications/tools, which may overlap with the first set or be distinct therefrom. One or more elements of the second set of applications/tools may thus comprise (an) element(s) of the first set.

The virtual trigger 27 may be disposed and operable, at least in part, over the first scan zone 51 and the second scan zone 52. An example embodiment may also be implemented in which the virtual trigger 27 may be moved between the first scan zone 51 and the second scan zone 52. Alternatively or additionally, separate or distinct instances of the virtual trigger 27 may be configured in each of the first scan zone 51 and the second scan zone 52.

The virtual trigger 27 may be configured with a first set of features operable in the first scan zone 51 and a second set of features operable in the second scan zone. One or more elements of the first feature set may differ or match one or more elements of the second feature set.

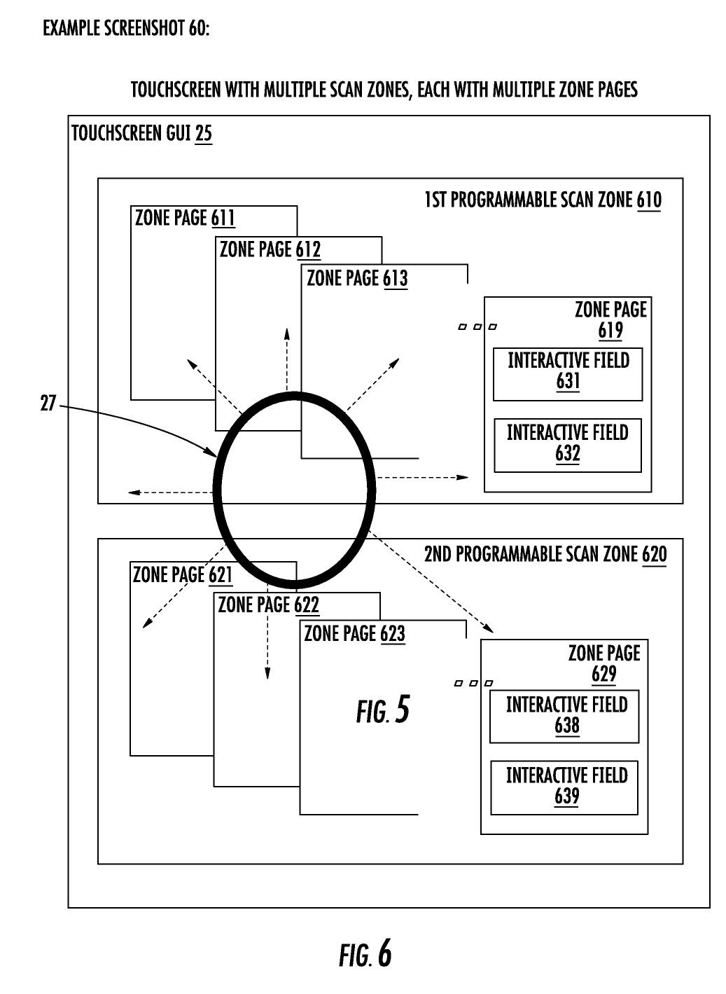

An example embodiment may be implemented in which one or more scan zones rendered on the touchscreen GUI 25 comprises one or more zone-pages. Each of the zone-pages may comprise one or more component sub-zones, which may be referred to herein as “interactive fields.” For example, FIG. 6 depicts a fourth screenshot 60, according to an embodiment. The screenshot 60 depicts an example plurality of scan zone-pages operable on the touchscreen GUI 25.

A first programmable scan zone 610 is disposed over a first section of the touchscreen 25, which has a first area or size, shape and contour. The first programmable scan zone 610 comprises a plurality, comprising one or more zone-pages represented by zone pages 611, 612, 613 and 619. Each of the multiple zone-pages of the first scan zone 610 may be operable with at least one first set of gestures for actuating a corresponding first set of applications/tools.

At least a second programmable scan zone 620 is disposed over a second section an area of the touchscreen 25, which has a second size or area, shape and contour. In an example embodiment, the mobile device 20 may also comprise up to any practical and practicable number of additional scan zones, which are represented by description of the second scan zone 620.

The second programmable scan zone 620 comprises a plurality (comprising one or more) zone-pages represented by zone pages 621, 622, 623 and 629. Each of the multiple zone-pages of the first scan zone 620 may be operable with at least one second set of gestures for actuating a corresponding first set of applications/tools.

The virtual trigger 27 may be configured with a first set of features operable in the first scan zone 610 and a second set of features operable in the second scan zone 620. One or more elements of the first feature set may differ or match one or more elements of the second feature set. Each of the zone-pages 610 and 620 may be rendered together on the touchscreen 25 in relative dispositions that present them separately from each other, as shown in FIG. 6.

Each of multiple zone-pages may also be rendered in relative dispositions that have at least partially overlapping contours, and may be accessed and used by touch based navigation between them. Each of multiple interactive fields, presented on each accessed zone-page, may be accessed and used by touch based navigation between them. Navigating between multiple zone-pages may be based on the dispositions in which they presented relative to each other of a particular scan-zone.

Thus, where each of the zone-pages is presented in a sequence disposed horizontally over a given scan-zone, navigating between them may relate to a gesture 28 made over a left/right orientation (or vice versa). For example, the zone-pages 611, 612, 613 and 619 are presented in an ordinal sequence relative to each other, which is disposed horizontally over the first scan zone 610. Navigating between each of the zone-pages 611, 612, 613 and 619 may be effectuated by left/right-oriented swipe gestures applied over the horizontal sequence.

Similarly, the zone-pages 621, 622, 623 and 629 are presented in an ordinal sequence relative to each other, which is disposed horizontally over the second scan zone 620. Navigating between each of the zone-pages 621, 622, 623 and 629 may also thus be effectuated by left/right-oriented swipe gestures applied over the horizontal sequence. Multiple zone-pages may also be presented in other arrangements or orientations, with navigation between them effectuated in correspondence therewith.

One or more of the zone-pages of the first programmable scan zone 610 or the second programmable scan zone 620 may comprise any practical and practicable number of interactive fields as component sub-zones. For example, at least the zone-page 619 and the zone-page 629 each comprise at least a pair of interactive fields. The zone-page 619 comprises an interactive field 631 and an interactive field 632. The zone-page 619 comprises an interactive field 631 and an interactive field 632.

Navigating between multiple interactive fields may also be based on the dispositions in which they presented relative to each other over a particular zone-page. Thus for example, where each of the interactive fields is presented in a sequence disposed vertically over a given zone-page, navigating between them may relate to a gesture 28 made over an up/down orientation (or vice versa).

Thus, where each of the interactive fields is presented in a sequence disposed vertically over a given zone-page, navigating between them may relate to a gesture 28 made over an up/down orientation (or vice versa). For example, the interactive fields 631 and 632 are presented in an ordinal sequence relative to each other, which is disposed vertically over the zone-page 619. The interactive fields 638 and 639 are presented in an ordinal sequence relative to each other, which is disposed vertically over the zone-page 629.

Navigating between each of the interactive fields 631 and 632 within the zone-page 619, and/or between each of the interactive fields 638 and 639 within the zone-page 629, may be effectuated by up/down-oriented swipe gestures applied over the corresponding vertical sequences. Multiple interactive fields may also be presented within various zoned-pages in other arrangements or orientations, with navigation between them effectuated in correspondence therewith.

The virtual trigger 27 may be rendered in a movable, re-sizable and/or re-configurable disposition presented over one or more of multiple scan-zones. One or more of multiple scan-zones may be enabled or disabled at any point of time by a gesture 28 or another touch-based input to the virtual trigger 27.

The virtual trigger 27 is thus disposed and operable over a part of the first scan zone 610 and a part of the second scan zone 620. An example embodiment may also be implemented in which the virtual trigger 27 may be moved between the first scan zone 610 and the second scan zone 620. Alternatively or additionally, separate or distinct virtual trigger instances may be configured in each of the first scan zone 610 and the second scan zone 620. The virtual trigger 27 may also be re-sized, re-shaped and/or re-configured based on its disposition and/or use in either of the scan-zones 610 or 620, and/or any of the zone-pages therein.

An example embodiment of the present invention is thus described in relation to the GUI operable on the touchscreen component 125 of the mobile device 20. At least one programmable scan zone 21 is disposed over a first portion of the touchscreen 25. The zone 25 is operable on the touchscreen 25 for receiving a first input upon an instance in time, and for invoking one or more functions of the mobile device 20, based on a user programmed context, in response to the received first input.

At least one configurable virtual trigger icon is disposed over a second portion of the touchscreen. The second portion comprises an area smaller than an area of the first portion. The at least one icon is operable, based on a user configured context or selection, for receiving a second input and triggering a corresponding action related to the one or more functions of the mobile device in response to the second input. The functions of the mobile device may comprise applications, tools, macros, and/or menus related to collecting or accessing data presented graphically, visually, electromagnetically, and/or sonically.

At the instance of time, one or more applications may be running on the mobile device. The invoking the one or more functions of the mobile device programmably in response to the received input may be performed concurrently with a function of the running applications. The zone and/or the icon may be rendered on the touchscreen over a presentation related to the running application.

The collected or accessed graphic or visual data may comprise a barcode pattern and/or an image. The collected/accessed electromagnetic data may relate to reading or scanning RFID or NFC tags. The collected/accessed sonic data may relate to audio inputs, and/or inputs related to voice-recognition and/or activation functions.

The second input may comprise a haptic gesture, such as a long-press and/or a long-press with a swipe. A size and/or dimension of the area of the first portion of the touchscreen, or a location thereof, may be adjustable based on one or more haptic inputs to the touchscreen.

An at least second programmable scan zone is disposed over a third portion of the touchscreen. The third portion comprises an area smaller than the area of the at least second portion. The third portion of the touchscreen is operable for receiving a third input, and based on another user programmed context, for invoking one or more functions of the mobile device programmably in response to the received third input.

Based on an activation input, each of the programmable scan zones may, selectively, be active or inactive. The programmable scan zones may comprise multiple interactive zone-pages. The interactive zone-pages may comprise multiple interactive fields, sub-zones or sub-pages.

Example Process.

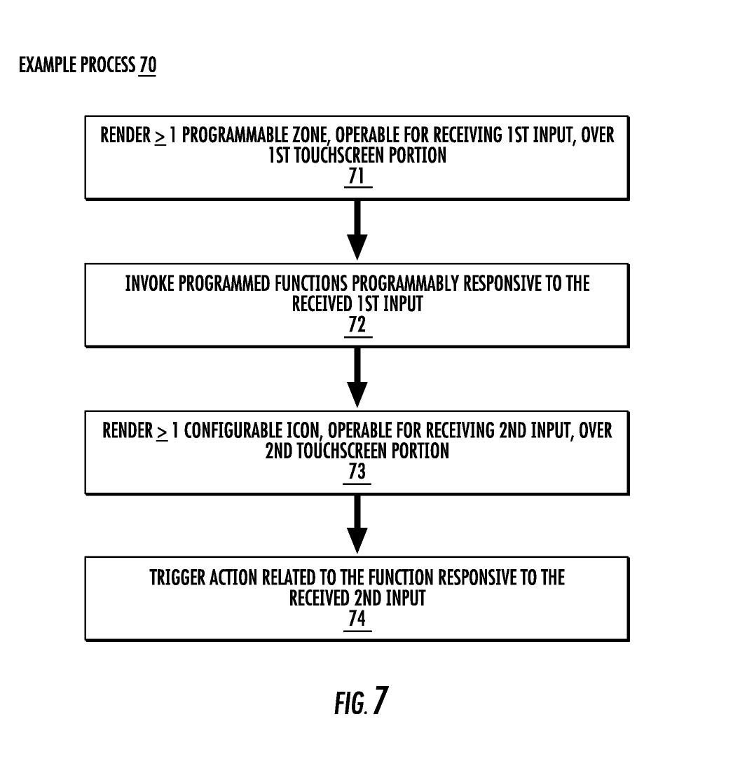

FIG. 7 depicts a flowchart for an example method 70 for operating the mobile device 20, according to an embodiment.

In a step 71, at least one programmable scan zone 21 is rendered over a first portion of the touchscreen 25. The rendered at least one programmable scan zone 21 is operable on the touchscreen 25 for receiving a first input upon an instance in time.

In a step 72, one or more functions of the mobile device 20 may be invoked in response to the received first input. The response is invoked based on a user programmed context.

In a step 73, at least one configurable virtual trigger icon is rendered over a second portion of the touchscreen. The second portion comprises an area smaller than an area of the first portion. The rendered at least one configurable virtual trigger icon is operable on the touchscreen for receiving a second input.

In a step 74, an action related to the one or more functions of the mobile device is triggered in response to the second input, based on a user configured context or selection. In an example embodiment, the functions of the mobile device comprise an application, a tool, a macro, and/or a menu or sub-menu related to collecting or accessing data presented graphically, visually, electromagnetically, or sonically.

The data may comprise barcode patterns, images, RFID and/or NFC tags, audio inputs, and/or inputs related to voice-recognition and/or voice-activation functions. The second input may relate to a haptic gesture, such as, for example, a long-press and/or a long-press with a swipe.

A size and/or dimension of the area of the first portion of the touchscreen, or a location thereof, are adjustable based on one or more haptic inputs to the touchscreen.

The method may further comprise rendering at least a second programmable scan zone disposed over a third portion of the touchscreen. The third portion may comprise an area larger than the area of at least the second portion. The rendered at least second programmable scan zone is operable for receiving a third input. One or more functions of the mobile device may be invoked, based on another user programmed context, in response to the received third input.

Based on an activation input, the programmable scan zone and/or the second programmable scan zone are, selectively, active or inactive.

An example embodiment is described in relation to a mobile device, which comprises at least one processor and a non-transitory computer readable storage medium. The non-transitory storage medium comprises instructions, which when executed by the at least one processor causes or controls a method performed therewith.

The method 70 comprises rendering at least one programmable scan zone over a first portion of a touchscreen of the mobile device. The rendered at least one programmable scan zone is operable on the touchscreen for receiving a first input upon an instance of time. One or more functions of the mobile device is invoked programmably in response to the received first input. At least one configurable virtual trigger icon is rendered over a second portion of the touchscreen.

The second portion comprises an area smaller than an area of the first portion. The rendered at least one configurable virtual trigger icon is operable on the touchscreen for receiving a second input.

An action related to the one or more functions of the mobile device is triggered in response to the second input. The functions of the mobile device comprise an application, a tool, a macro, and/or a menu related to collecting or accessing data presented graphically, visually, electromagnetically, or sonically.

The data may comprise barcode patterns, images, RFID and/or NFC tags, audio inputs, and/or inputs related to voice-recognition and/or voice-activation functions. The second input may relate to a haptic gesture, such as a long-press and/or a long-press with a swipe.

A size and/or dimension of the area of the first portion of the touchscreen, or a location thereof, are adjustable based on one or more haptic inputs to the touchscreen.

The method 70 may further comprise rendering at least a second programmable scan zone disposed over a third portion of the touchscreen. The third portion may comprise an area smaller than the area of at least the second portion. The rendered at least second programmable scan zone is operable for receiving a third input. One or more functions of the mobile device may be invoked, based on another user programmed context, in response to the received third input.

Based on an activation input, the programmable scan zone and/or the second programmable scan zone are, selectively, active or inactive.

An example embodiment is described in relation to a mobile device, which comprises at least one processor and a non-transitory computer readable storage medium. The non-transitory storage medium comprises instructions, which when executed by the at least one processor causes or controls a performance of the method 70.

Example Mobile Device and Computer/Network Platform.

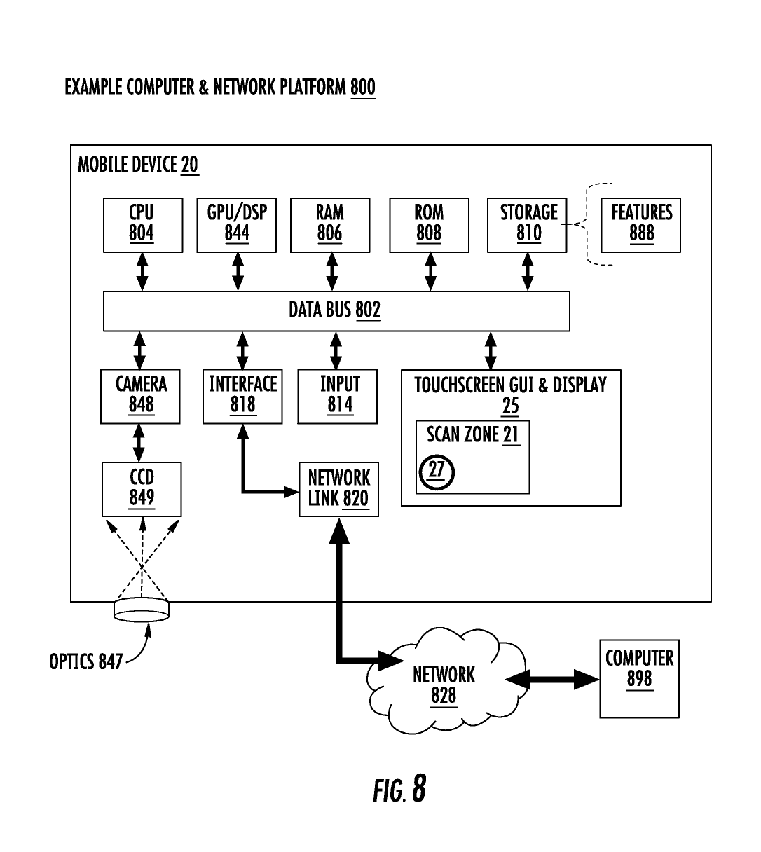

FIG. 8 depicts an example computer and network platform 800, with which an example embodiment may be implemented. The computer and network platform 800 comprises the mobile device 20, a network 828, and at least one computer 898. The mobile device 20 is communicatively coupled via the network 828 with the at least one computer 898. The network 828 may comprise a packet-switched data network operable based on transfer control and internetworking protocols, such as TCP/IP.

For example, the network 828 may comprise a digital telephone network. The network 828 may comprise a portion of one or more other networks and/or two or more sub-networks (“subnets”). For example, the network 828 may comprise a portion of the internet and/or a particular wide area network (WAN). The network 828 may also comprise one or more WAN and/or local area network (LAN) subnet components. Portions of the network 828 may be operable wirelessly and/or with wireline related means.

The computer 898 may comprise another mobile device or a computer operable at a particular location, where it may be disposed in a more or less fixed, or at least stationary position or configuration. In relation to the mobile device 20, the computer 898 may also be operable as a server and/or for performing one or more functions relating to control or centralized pooling, processing or storage of information gathered or accessed therewith.

For example, embodiments of the present invention may be implemented in which the mobile device 20 is operable for capturing images photographically (including recording video) and/or scanning and reading barcode patterns and other data presented by graphic media. The images and data associated with the barcode may be sent to the computer 898. The mobile device 20 may thus be used for scanning a barcode and reading data (e.g., inventory information, price, etc.) therefrom in relation to an associated item (e.g., stock, product, commodity, etc.).

The mobile device 20 may then send the scan related data wirelessly, via the network 828, to the computer 898. Upon receipt thereof, the computer 898 may be operable for processing the scan related data in relation to a sale, transfer or other disposition of the item associated with the barcode. The processing of the data may thus allow, for example, updating a database 877 (e.g., inventory) in relation to the item associated with the scanned barcode.

An example embodiment is implemented in which the mobile device 20 comprises a data bus 802 and various other components, which are described below. The data bus 802 is operable for allowing each of the various components of the mobile device 20 described herein to exchange data signals with each of the other components.

The mobile device 20 comprises at least one CPU 804, such as a microprocessor device. The CPU 804 is operable as a central processing unit (CPU) for performing general data processing functions. The mobile device 20 may also comprise one or more processors operable as a “math” (mathematics) coprocessor, a digital signal processor (DSP) or a graphics processing unit (GPU) 844 operable for performing more processing functions that may be somewhat specialized relative to perhaps more generalized processing operations that may be performed, e.g. by the CPU 804.

The DSP/GPU (or other specialized processor) 844 may be operable, for example, for performing computationally intense data processing in relation to graphics, images and other (e.g., mathematical, financial) information. Data processing operations comprise computations performed electronically by the CPU 804 and the DSP/GPU 844.

For example, microprocessors may comprise components operable as an arithmetic logic unit (ALU), a floating point logic unit (FPU), and associated memory cells. The memory cells may be configured as caches (e.g., “L1,” “L2”), registers, latches and/or buffers, which may be operable for storing data electronically in relation to various functions of the processor. For example, a translational look-aside buffer (TLB) may be operable for optimizing efficiency of content-addressable memory (CAM) use by the CPU 804 and/or the DSP/GPU 844.

The mobile device 20 also comprises non-transitory computer readable storage media operable for storing data electronically. For example, the mobile device 20 comprises a main memory 806, such as a random access memory (RAM) or other dynamic storage device 806. The main memory 806 is coupled to data bus 802 for storing information and instructions, which are to be executed by the CPU 804. The main memory 806 also may be used for storing temporary variables or other intermediate information during execution of instructions by the CPU 804. Other memories (represented in the present description with reference to the RAM 806) may be installed for similar uses by the DSP/GPU 844.

The mobile device 20 further comprises a read-only memory (ROM) 808 or other static storage device coupled to the data bus 802. The ROM 808 is operable for storing static information and instructions for use by the CPU 804. A storage device 810, such as a magnetic disk drive, flash drive, or optical disk drive, comprises a non-transitory medium coupled to data bus 802 for storing information and instructions.

Software and programming instructions, settings and configurations related to a suite of features 888 may be stored magnetically, electronically or optically by the non-transitory storage medium 810. An example embodiment may be implemented in which suite of features 888 relates to applications, tools and tool sets, menus (and sub-menus) and macros associated with functions of the mobile device 20 related to scanning and reading barcode patterns, taking photographs, recording video information, and capturing other data related to images and presentations of graphic media.

The mobile device 20 comprises the touchscreen GUI and display component 25. The touchscreen 25 comprises a liquid crystal display (LCD), which is operable for rendering images based on modulating variable polarization states of liquid crystal transistor devices. The touchscreen 25 also comprises an interface operable for receiving haptic inputs.

The haptic interface may comprise, e.g., at least two arrays of microscopic (or transparent) conductors, each of which is insulated electrically from the other and disposed beneath a surface of the display 25 in a perpendicular orientation relative to the other. The haptic inputs comprise pressure applied to the surface of the touchscreen GUI 25, which cause corresponding local changes in electrical capacitance values proximate to the pressure application that are sensed by the conductor grids to effectuate a signal corresponding to the input.

In an example embodiment, the touchscreen GUI and display component 25 is operable for rendering one or more specially-interactive scan zones 21 based on programming selections made according to a user's preference. In an example embodiment likewise, the touchscreen GUI and display component 25 is operable for rendering at least one specially-interactive virtual trigger 27, e.g., over a portion of the programmable scan zone 21, according to configuration settings made based on the user's preference.

The touchscreen GUI component 25 may be implemented operably for rendering images over a heightened (e.g., high) dynamic range (HDR), the rendering of the images may also be based on modulating a back-light unit (BLU). For example, the BLU may comprise an array of light emitting diodes (LEDs). The LCDs may be modulated according to a first signal and the BLU may be modulated according to a second signal. The touchscreen 25 may render an HDR image by coordinating the second modulation signal in real time, relative to the first modulation signal.

An input device 814 may comprise an electromechanical switch, which may be implemented as a button, escutcheon, or cursor control. The input device 814 may also be implemented in relation to an array of alphanumeric (and/or ideographic, syllabary based) and directional (e.g., “up/down,” “left/right”) keys, operable for communicating commands and data selections to the CPU 804 and for controlling movement of a cursor rendering over the touchscreen GUI display 25.

The input device 814 may be operable for presenting two (2) degrees of freedom of a cursor over at least two (2) perpendicularly disposed axes presented on the display component of the touchscreen GUI 25. A first ‘x’ axis is disposed horizontally. A second ‘y’ axis, complimentary to the first axis, is disposed vertically. Thus, the mobile device 20 is operable for specifying positions over a representation of a geometric plane.

Example embodiments of the present invention relate to the use of the mobile device 20 for scanning visual data such as barcode patterns and/or other images presented on printed graphic media and/or self-lit electronic displays. Example embodiments of the present invention also relate to the use of the mobile device 20 for taking photographs and recording video. A camera component 848 is coupled to the data bus 802. The camera component 848 is operable for receiving data related to the scanned barcode patterns.

The camera component 848 is also operable for receiving static and dynamic image data related, respectively, to the photographs and the video. The camera component 848 may receive the data captured from an image sensor 849. The image sensor 849 may comprise an array of charge-coupled devices (CCDs), photodiodes (PDs), or active complementary metal oxide semiconductor (CMOS) based imaging devices. The image sensor 849 may be operable with a system of optical components (“optics”) 847. The barcode scanning (and other) feature(s) of the mobile device 20 may be operable with one or more of the camera component 848, the image sensor component 849, and/or the optics 847.

The programming related to the scan zone 21, the configuring of the virtual trigger 27, and the features of the functionality suite 888 may be provided, controlled, enabled or allowed with mobile device 20 functioning in response to the CPU 804 executing one or more sequences of instructions contained in main memory 806 and/or other non-transitory computer readable storage media. The instructions may be read into main memory 806, via the data bus 802, from another computer-readable medium, such as the storage device 810.

Execution of the instruction sequence contained in the main memory 806 causes the CPU 804 to perform the process steps described with reference to FIG. 7 in relation to the method 70. One or more processors in a multi-processing arrangement may also be employed to execute the sequences of instructions contained in main memory 806.

In alternative embodiments, hard-wired circuitry may be used in place of, or in combination with, software instructions for implementing the programming related to the scan zone 21, the configuring of the virtual trigger 27, or the features of the functionality suite 888. Thus, example embodiments of the present invention are not limited to any specific combination of circuitry, hardware, firmware and/or software.

The term “computer readable storage medium,” as used herein, may refer to any non-transitory storage medium that participates in providing instructions to CPU 804 (and the DSP/GPU 844) for execution. Such a medium may take many forms, including but not limited to, non-volatile media, volatile media, and transmission media. Non-volatile media comprises, for example, optical or magnetic disks, such as storage device 810. Volatile media comprises dynamic memory, such as main memory 806.

Transmission media comprises coaxial cables, copper wire and other electrical conductors and fiber optics, including the wires (and/or other conductors or optics) that comprise the data bus 802. Transmission media can also take the form of electromagnetic (e.g., light) waves, such as those generated during radio wave and infrared and other optical data communications (and acoustic, e.g., sound related, or other mechanical, vibrational, or phonon related transmissive media.

Non-transitory computer-readable storage media may comprise, for example, flash drives such as may be accessible via USB (universal serial bus) or any medium from which a computer can read data.

Various forms of non-transitory computer readable storage media may be involved in carrying one or more sequences of one or more instructions to CPU 804 for execution. For example, the instructions may initially be carried on a magnetic or other disk of a remote computer (e.g., computer 898). The remote computer can load the instructions into its dynamic memory and send the instructions over networks 828.

The mobile device 20 can receive the data over the network 828 and use an infrared or other transmitter to convert the data to an infrared or other signal. An infrared or other detector coupled to the data bus 802 can receive the data carried in the infrared or other signal and place the data on data bus 802. The data bus 802 carries the data to main memory 806, from which CPU 804 retrieves and executes the instructions. The instructions received by main memory 806 may optionally be stored on storage device 810 either before or after execution by CPU 804.

The mobile device 20 also comprises a communication interface 818 coupled to the data bus 802. The communication interface 818 provides a two-way (or more) data communication coupling to a network link 820, which may connect to the network 828. In any implementation, the communication interface 818 sends and receives electrical, electromagnetic or optical signals that carry digital data streams representing various types of information. The network link 820 provides data communication through the network 828 to other data devices.

The network 828 may use one or more of electrical, electromagnetic, and/or optical signals carrying digital data streams. The signals sent over the network 828 and through the network link 820 and communication interface 818 carry the digital data to and from the mobile device 20. The mobile device 20 can send messages and receive data, including program code, through the network 828, network link 820 and communication interface 818.

Example embodiments of the present invention are thus described. Example embodiments relate to a mobile device, a method for operating the mobile device, and a GUI operable on a touchscreen component of the mobile device. The GUI comprises at least one programmable scan zone disposed over a first portion of the touchscreen. The GUI is operable on the touchscreen for receiving a first input at an instance in time, and for invoking one or more functions of the mobile device programmably in response to the received first input. The GUI also comprises at least one configurable virtual trigger icon disposed over a second portion of the touchscreen. The second portion comprises an area smaller than an area of the first portion. The at least one icon is operable, based on a configuration, for receiving a second input and triggering a corresponding action related to the one or more functions of the mobile device in response to the second input.

The functions of the mobile device comprise one or more of an application, a tool, a macro or a menu related to collecting or accessing data presented graphically (e.g., barcodes), visually (e.g., images), electromagnetically (e.g., RFID), or sonically (e.g., voice commands or audio data). The mobile devices may comprise smartphones, tablets and/or other mobile computer devices, PDTs and/or PDAs.

In the specification and/or figures of the present Application, embodiments of the invention have been described in relation to an example GUI operable on a touchscreen component of a mobile device. The GUI comprises at least one programmable scan zone disposed over a first portion of the touchscreen. The GUI is operable on the touchscreen for receiving a first input at an instance in time, and for invoking one or more functions of the mobile device, based on a user programmed context, in response to the received first input. The GUI also comprises at least one configurable virtual trigger icon disposed over a second portion of the touchscreen. The second portion comprises an area smaller than an area of the first portion. The at least one icon is operable, based on a user configured selection or context, for receiving a second input and triggering a corresponding action related to the one or more functions of the mobile device in response to the second input. The functions of the mobile device comprise one or more of an application, a tool, a macro or a menu related to collecting or accessing data presented graphically (e.g., barcodes), visually (e.g., images), electromagnetically (e.g., RFID, NFC, etc. tags), or sonically (e.g., voice commands or audio data).

The present invention is not limited to such example embodiments. Embodiments of the present invention also relate to equivalents of the examples described herein. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

An example embodiment of the present invention relates to a GUI operable on a touchscreen component of a mobile device. The GUI comprises at least one programmable scan zone disposed over a first portion of the touchscreen. The GUI is operable on the touchscreen for receiving a first input at an instance in time, and for invoking one or more functions of the mobile device, based on a user programmed context, in response to the received first input. The GUI also comprises at least one configurable virtual trigger icon disposed over a second portion of the touchscreen. The second portion comprises an area smaller than an area of the first portion. The at least one icon is operable, based on a user configured selection or context, for receiving a second input and triggering a corresponding action related to the one or more functions of the mobile device in response to the second input.

The functions of the mobile device comprise one or more of an application, a tool, a macro or a menu related to collecting or accessing data presented graphically (e.g., barcodes), visually (e.g., images), electromagnetically (e.g., RFID and/or NFC tags), or sonically (e.g., voice commands or audio data). The mobile device may be operable with functions multiple or various features. The features relate applications, tools and tool sets, menus (and submenus), and macros relating to scanning barcodes and other patterns of graphic data, processing images and video data, scanning RFID and NFC tags, and voice and/or audio data. The mobile devices may comprise smartphones, tablets and/or other mobile computer devices, PDTs and/or PDAs.

To supplement the specification of the present disclosure, the present application incorporates by reference, in their entirety, the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,526;
U.S. Pat. No. 8,798,367; U.S. Pat. No. 8,807,431;
U.S. Pat. No. 8,807,432; U.S. Pat. No. 8,820,630;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2011/0202554;
U.S. Patent Application Publication No. 2012/0111946;
U.S. Patent Application Publication No. 2012/0138685;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0056285;
U.S. Patent Application Publication No. 2013/0070322;
U.S. Patent Application Publication No. 2013/0075168;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0200158;
U.S. Patent Application Publication No. 2013/0256418;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0278425;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306730;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0341399;
U.S. Patent Application Publication No. 2013/0342717;
U.S. Patent Application Publication No. 2014/0001267;
U.S. Patent Application Publication No. 2014/0002828;
U.S. Patent Application Publication No. 2014/0008430;
U.S. Patent Application Publication No. 2014/0008439;
U.S. Patent Application Publication No. 2014/0025584;
U.S. Patent Application Publication No. 2014/0027518;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061305;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0075846;
U.S. Patent Application Publication No. 2014/0076974;
U.S. Patent Application Publication No. 2014/0078341;
U.S. Patent Application Publication No. 2014/0078342;
U.S. Patent Application Publication No. 2014/0078345;
U.S. Patent Application Publication No. 2014/0084068;
U.S. Patent Application Publication No. 2014/0097249;
U.S. Patent Application Publication No. 2014/0098792;
U.S. Patent Application Publication No. 2014/0100774;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0108682;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0160329;
U.S. Patent Application Publication No. 2014/0166755;
U.S. Patent Application Publication No. 2014/0166757;
U.S. Patent Application Publication No. 2014/0166759;
U.S. Patent Application Publication No. 2014/0166760;
U.S. Patent Application Publication No. 2014/0166761;
U.S. Patent Application Publication No. 2014/0168787;
U.S. Patent Application Publication No. 2014/0175165;
U.S. Patent Application Publication No. 2014/0175169;
U.S. Patent Application Publication No. 2014/0175172;
U.S. Patent Application Publication No. 2014/0175174;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0203087;
U.S. Patent Application Publication No. 2014/0204268;
U.S. Patent Application Publication No. 2014/0214631;
U.S. Patent Application Publication No. 2014/0217166;
U.S. Patent Application Publication No. 2014/0217180;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/436,337 for an Electronic Device, filed Nov. 5, 2012 (Fitch et al.);
U.S. patent application Ser. No. 13/771,508 for an Optical Redirection Adapter, filed Feb. 20, 2013 (Anderson);
U.S. patent application Ser. No. 13/852,097 for a System and Method for Capturing and Preserving Vehicle Event Data, filed Mar. 28, 2013 (Barker et al.);
U.S. patent application Ser. No. 13/902,110 for a System and Method for Display of Information Using a Vehicle-Mount Computer, filed May 24, 2013 (Hollifield);
U.S. patent application Ser. No. 13/902,144, for a System and Method for Display of Information Using a Vehicle-Mount Computer, filed May 24, 2013 (Chamberlin);
U.S. patent application Ser. No. 13/902,242 for a System For Providing A Continuous Communication Link With A Symbol Reading Device, filed May 24, 2013 (Smith et al.);
U.S. patent application Ser. No. 13/912,262 for a Method of Error Correction for 3D Imaging Device, filed Jun. 7, 2013 (Jovanovski et al.);
U.S. patent application Ser. No. 13/912,702 for a System and Method for Reading Code Symbols at Long Range Using Source Power Control, filed Jun. 7, 2013 (Xian et al.);
U.S. patent application Ser. No. 29/458,405 for an Electronic Device, filed Jun. 19, 2013 (Fitch et al.);
U.S. patent application Ser. No. 13/922,339 for a System and Method for Reading Code Symbols Using a Variable Field of View, filed Jun. 20, 2013 (Xian et al.);
U.S. patent application Ser. No. 13/927,398 for a Code Symbol Reading System Having Adaptive Autofocus, filed Jun. 26, 2013 (Todeschini);
U.S. patent application Ser. No. 13/930,913 for a Mobile Device Having an Improved User Interface for Reading Code Symbols, filed Jun. 28, 2013 (Gelay et al.);
U.S. patent application Ser. No. 29/459,620 for an Electronic Device Enclosure, filed Jul. 2, 2013 (London et al.);
U.S. patent application Ser. No. 29/459,681 for an Electronic Device Enclosure, filed Jul. 2, 2013 (Chaney et al.);
U.S. patent application Ser. No. 13/933,415 for an Electronic Device Case, filed Jul. 2, 2013 (London et al.);
U.S. patent application Ser. No. 29/459,785 for a Scanner and Charging Base, filed Jul. 3, 2013 (Fitch et al.);
U.S. patent application Ser. No. 29/459,823 for a Scanner, filed Jul. 3, 2013 (Zhou et al.);
U.S. patent application Ser. No. 13/947,296 for a System and Method for Selectively Reading Code Symbols, filed Jul. 22, 2013 (Rueblinger et al.);
U.S. patent application Ser. No. 13/950,544 for a Code Symbol Reading System Having Adjustable Object Detection, filed Jul. 25, 2013 (Jiang);
U.S. patent application Ser. No. 13/961,408 for a Method for Manufacturing Laser Scanners, filed Aug. 7, 2013 (Saber et al.);
U.S. patent application Ser. No. 14/018,729 for a Method for Operating a Laser Scanner, filed Sep. 5, 2013 (Feng et al.);
U.S. patent application Ser. No. 14/019,616 for a Device Having Light Source to Reduce Surface Pathogens, filed Sep. 6, 2013 (Todeschini);
U.S. patent application Ser. No. 14/023,762 for a Handheld Indicia Reader Having Locking Endcap, filed Sep. 11, 2013 (Gannon);
U.S. patent application Ser. No. 14/035,474 for Augmented-Reality Signature Capture, filed Sep. 24, 2013 (Todeschini);
U.S. patent application Ser. No. 29/468,118 for an Electronic Device Case, filed Sep. 26, 2013 (Oberpriller et al.);
U.S. patent application Ser. No. 14/055,234 for Dimensioning System, filed Oct. 16, 2013 (Fletcher);
U.S. patent application Ser. No. 14/053,314 for Indicia Reader, filed Oct. 14, 2013 (Huck);
U.S. patent application Ser. No. 14/065,768 for Hybrid System and Method for Reading Indicia, filed Oct. 29, 2013 (Meier et al.);
U.S. patent application Ser. No. 14/074,746 for Self-Checkout Shopping System, filed Nov. 8, 2013 (Hejl et al.);
U.S. patent application Ser. No. 14/074,787 for Method and System for Configuring Mobile Devices via NFC Technology, filed Nov. 8, 2013 (Smith et al.);
U.S. patent application Ser. No. 14/087,190 for Optimal Range Indicators for Bar Code Validation, filed Nov. 22, 2013 (Hejl);
U.S. patent application Ser. No. 14/094,087 for Method and System for Communicating Information in an Digital Signal, filed Dec. 2, 2013 (Peake et al.);
U.S. patent application Ser. No. 14/101,965 for High Dynamic-Range Indicia Reading System, filed Dec. 10, 2013 (Xian);
U.S. patent application Ser. No. 14/150,393 for Indicia-reader Having Unitary Construction Scanner, filed Jan. 8, 2014 (Colavito et al.);
U.S. patent application Ser. No. 14/154,207 for Laser Barcode Scanner, filed Jan. 14, 2014 (Hou et al.);
U.S. patent application Ser. No. 14/165,980 for System and Method for Measuring Irregular Objects with a Single Camera filed Jan. 28, 2014 (Li et al.);
U.S. patent application Ser. No. 14/166,103 for Indicia Reading Terminal Including Optical Filter filed Jan. 28, 2014 (Lu et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 14/250,923for Reading Apparatus Having Partial Frame Operating Mode filed Apr. 11, 2014, (Deng et al.);
U.S. patent application Ser. No. 14/257,174 for Imaging Terminal Having Data Compression filed Apr. 21, 2014, (Barber et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/274,858 for Mobile Printer with Optional Battery Accessory filed May 12, 2014 (Marty et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/300,276 for METHOD AND SYSTEM FOR CONSIDERING INFORMATION ABOUT AN EXPECTED RESPONSE WHEN PERFORMING SPEECH RECOGNITION, filed Jun. 10, 2014 (Braho et al.);
U.S. patent application Ser. No. 14/305,153 for INDICIA READING SYSTEM EMPLOYING DIGITAL GAIN CONTROL filed Jun. 16, 2014 (Xian et al.);
U.S. patent application Ser. No. 14/310,226 for AUTOFOCUSING OPTICAL IMAGING DEVICE filed Jun. 20, 2014 (Koziol et al.);
U.S. patent application Ser. No. 14/327,722 for CUSTOMER FACING IMAGING SYSTEMS AND METHODS FOR OBTAINING IMAGES filed Jul. 10, 2014 (Oberpriller et al,);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/329,303 for CELL PHONE READING MODE USING IMAGE TIMER filed Jul. 11, 2014 (Coyle);
U.S. patent application Ser. No. 14/333,588 for SYMBOL READING SYSTEM WITH INTEGRATED SCALE BASE filed Jul. 17, 2014 (Barten);
U.S. patent application Ser. No. 14/334,934 for a SYSTEM AND METHOD FOR INDICIA VERIFICATION, filed Jul. 18, 2014 (Hejl);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/340,716 for an OPTICAL IMAGER AND METHOD FOR CORRELATING A MEDICATION PACKAGE WITH A PATIENT, filed Jul. 25, 2014 (Ellis);
U.S. patent application Ser. No. 14/342,544 for Imaging Based Barcode Scanner Engine with Multiple Elements Supported on a Common Printed Circuit Board filed Mar. 4, 2014 (Liu et al.);
U.S. patent application Ser. No. 14/345,735 for Optical Indicia Reading Terminal with Combined Illumination filed Mar. 19, 2014 (Ouyang);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/355,613 for Optical Indicia Reading Terminal with Color Image Sensor filed May 1, 2014 (Lu et al.);
U.S. patent application Ser. No. 14/370,237 for WEB-BASED SCAN-TASK ENABLED SYSTEM AND METHOD OF AND APPARATUS FOR DEVELOPING AND DEPLOYING THE SAME ON A CLIENT-SERVER NETWORK filed Jul. 2, 2014 (Chen et al.);
U.S. patent application Ser. No. 14/370,267 for INDUSTRIAL DESIGN FOR CONSUMER DEVICE BASED SCANNING AND MOBILITY, filed Jul. 2, 2014 (Ma et al.);
U.S. patent application Ser. No. 14/376,472, for an ENCODED INFORMATION READING TERMINAL INCLUDING HTTP SERVER, filed Aug. 4, 2014 (Lu);
U.S. patent application Ser. No. 14/379,057 for METHOD OF USING CAMERA SENSOR INTERFACE TO TRANSFER MULTIPLE CHANNELS OF SCAN DATA USING AN IMAGE FORMAT filed Aug. 15, 2014 (Wang et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/460,387 for APPARATUS FOR DISPLAYING BAR CODES FROM LIGHT EMITTING DISPLAY SURFACES filed Aug. 15, 2014 (Van Horn et al.);
U.S. patent application Ser. No. 14/460,829 for ENCODED INFORMATION READING TERMINAL WITH WIRELESS PATH SELECTION CAPABILITY, filed Aug. 15, 2014 (Wang et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/446,387 for INDICIA READING TERMINAL PROCESSING PLURALITY OF FRAMES OF IMAGE DATA RESPONSIVELY TO TRIGGER SIGNAL ACTIVATION filed Jul. 30, 2014 (Wang et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 29/486,759 for an Imaging Terminal, filed Apr. 2, 2014 (Oberpriller et al.);
U.S. patent application Ser. No. 29/492,903 for an INDICIA SCANNER, filed Jun. 4, 2014 (Zhou et al.); and
U.S. patent application Ser. No. 29/494,725 for an IN-COUNTER BARCODE SCANNER, filed Jun. 24, 2014 (Oberpriller et al.).

What is claimed, is:

1. A graphical user interface (GUI) operable on a touchscreen component of a mobile device, the GUI comprising:
at least one programmable scan zone disposed over a first portion of the touchscreen and operable on the touchscreen for receiving a first input at an instance in time, and for invoking one or more functions of the mobile device, based on a user programmed context, in response to the received first input; and
at least one configurable virtual trigger icon disposed over a second portion of the touchscreen, the second portion comprising an area smaller than an area of the first portion, the at least one virtual trigger icon operable, based on a user configured selection or context, for receiving a second input and triggering a corresponding action related to the one or more functions of the mobile device in response to the second input, wherein the functions of the mobile device comprise one or more of an application, a tool, a macro or a menu or sub-menu related to collecting or accessing data presented graphically, visually, electromagnetically, or sonically.

2. The GUI as described in claim 1 wherein at the instance in time, at least one application is running on the mobile device and wherein the invoking the one or more functions of the mobile device according to the user programmed context in response to the received input is performed concurrently with a function of the at least one running application.

3. The GUI as described in claim 2 wherein one or more of the programmable scan zone or the configurable virtual trigger icon are rendered on the touchscreen over a presentation related to the running application.

4. The GUI as described in claim 1 wherein the collected or accessed graphic or visual data comprise one or more of a barcode pattern or an image.

5. The GUI as described in claim 1 wherein the collected electromagnetic data comprise one or more of a radio frequency identification (RFID) tag or a near field communication (NFC) tag.

6. The GUI as described in claim 1 wherein the collected or accessed sonic data comprise at least one of an audio input or an input related to one or more voice-recognition or voice-activation functions.

7. The GUI as described in claim 1 wherein at least the second input comprises a gesture applied haptically.

8. The GUI as described in claim 7 wherein the haptically applied gesture comprises one or more long-press or a long-press with a swipe.

9. The GUI as described in claim 1 wherein at least one of a size, dimension, contour, shape, or location of the area of the first portion of the touchscreen are adjustable based on one or more haptic inputs to the touchscreen.

10. The GUI as described in claim 1, further comprising at least a second programmable scan zone disposed over a third portion of the touchscreen, the third portion comprising an area larger than the area of at least the second portion and operable on the touchscreen for receiving a third input, and for invoking one or more functions of the mobile device in response to the received third input based on a second user programmed context.

11. The GUI as described in claim 10 wherein based on an activation input, one or more of the at least one programmable scan zone, or the at least the second programmable scan zone are, selectively, active or inactive.

12. The GUI as described in claim 1 wherein the at least one programmable scan zone comprises one or more interactive zone-pages.

13. The GUI as described in claim 12 wherein at least one of the one or more interactive zone-pages comprises a plurality of interactive fields, sub-zones or sub-pages.

14. A method for operating a mobile device, the method comprising:
rendering at least one programmable scan zone over a first portion of a touchscreen of the mobile device, the rendered at least one programmable scan zone operable on the touchscreen for receiving a first input upon an instance in time;
invoking one or more functions of the mobile device, based on a user programmed context, in response to the received first input;
rendering at least one configurable virtual trigger icon over a second portion of the touchscreen, the second portion comprising an area smaller than an area of the first portion, the rendered at least one configurable virtual trigger icon operable on the touchscreen for receiving a user configured second input; and
triggering an action related to the one or more functions of the mobile device in response to the second input and based on a user configured correspondence, wherein the functions of the mobile device comprise one or more of an application, a tool, a macro, or a menu or sub-menu related to collecting or accessing data presented graphically, visually, electromagnetically, or sonically.

15. The method as described in claim 14 wherein the data comprise one or more of a barcode pattern, an image, a radio frequency identification (RFID) tag, a near field communication (NFC) tag, or at least one of an audio input or an input related to one or more voice-recognition or voice-activation functions.

16. The method as described in claim 14 wherein at least the second input relates to a haptic gesture comprising at least one of a long-press or a long-press with a swipe.

17. The method as described in claim 14 wherein at least one of a size, dimension, contour, shape or location of the area of the first portion of the touchscreen are adjustable based on one or more haptic inputs to the touchscreen corresponding to a user configured context.

18. The method as described in claim 14, further comprising:
rendering at least a second programmable scan zone disposed over a third portion of the touchscreen, the third portion comprising an area larger than the area of at least the second portion, the rendered at least second programmable scan zone operable for receiving a third input; and
invoking one or more functions of the mobile device programmably in response to the received third input.

19. The method as described in claim 14 wherein, based on an activation input, one or more of the at least one programmable scan zone, or the at least the second programmable scan zone are, selectively, active or inactive.

20. A mobile device comprising:
at least one processor; and
a non-transitory computer readable storage medium comprising instructions, which when executed by the at least one processor causes or controls a method performed therewith and comprising:
rendering at least one programmable scan zone over a first portion of a touchscreen of the mobile device, the rendered at least one programmable scan zone operable on the touchscreen, based on a user programmed context, for receiving a first input upon an instance in time;
invoking one or more functions of the mobile device, based on the user programmed context, in response to the received first input;
rendering at least one configurable virtual trigger icon over a second portion of the touchscreen, the second portion comprising an area smaller than an area of the first portion, the rendered at least one configurable virtual trigger icon operable on the touchscreen, based on a user configured selection or context, for receiving a second input; and
triggering an action related to the one or more functions of the mobile device, based on the user configured selection or context, in response to the second input, wherein the functions of the mobile device comprise one or more of an application, a tool, a macro, or a menu or sub-menu related to collecting or accessing data presented graphically, visually, electromagnetically, or sonically.
